(19) United States
(12) Patent Application Publication
(10) Pub. No.: US 2014/0122588 A1
(43) Pub. Date: May 1, 2014

(54) Automatic Notification of Audience Boredom during Meetings and Conferences

(71) Applicant: Alain Nimri, Austin, TX (US)

(72) Inventor: Alain Nimri, Austin, TX (US)

(21) Appl. No.: 13/665,794

(22) Filed: Oct. 31, 2012

(51) Int. Cl. G06F 15/16

(52) U.S. Cl. 709/204

(57) ABSTRACT

During a conference, a multipoint control unit (MCU) designates speaker and audience endpoints. The MCU receives votes from peripheral devices at the audience endpoints. The votes are aggregated and compared against a threshold by the MCU, and the MCU sends a notification or indication to the speaker endpoints if the threshold is exceeded. The votes have a lifespan over which they are valid. The votes may be weighted when there are targeted and non-targeted audience participants.

### BACKGROUND

Oftentimes, in face-to-face or remote meetings or conferences, a listener may encounter a presenter who spends too much time on topics that deviate from the primary presentation subject, topics that may be more appropriately discussed in a subsequent meeting or discussion, or topics that address only the concerns of a small number of participants. In these instances, not only will the presenter lose the attention of many audience participants, but the audience participants may feel their time is being wasted. However, out of courtesy towards the presenter, participants usually do not interrupt the presenter to refocus the discussion. An individual listener also may not want to be singled out for complaining or commenting about the discussion. Or, a participant may feel that while the subject is off-topic to them individually, the majority of the participants are likely engaged. At the same time, that individual listener may not realize that many others in the audience share the same sentiments.

In these situations, even with the best of intentions, the presenter may not realize that he/she is losing the audience, not engaging with the audience, or is off-topic. This serves to often defeat the purpose of the discussion or presentation, which is usually to inform, engage, and communicate with others. The problem can be particularly exacerbated in a video or audio conference because the current speaker or presenter may not be able to directly see or physically monitor the interest level of the other participants in the conference. Moreover, in large lectures or meetings with a great number of audience participants, the current presenter may not be able to judge the attitude of the participants in the audience.

The subject matter of the present disclosure is directed to overcoming, or at least reducing the effects of, one or more of the problems set forth above.

### SUMMARY

The subject matter of the present disclosure attempts to solve the problems set forth above by gently and politely informing the presenter of the average feeling of the audience participants about the presenter's presentation during an audio or video conference or meeting. During a presentation, audience participants can indicate whether they feel like the presenter is on a relevant topic or whether the presenter is going off-topic and the audience is getting bored. Considerations may be made for scenarios where a new presenter begins speaking, where a presentation is directed at a subset of audience participants, where audience participants share viewing or listening endpoints, and/or where other particular situations exist.

According to the present disclosure, audience participants can assess a presentation conducted by a presenting participant. Devices in the presentation are designated at a control unit. For example, designating the devices can be initially performed when reserving a conference, starting a conference, or communicatively connecting one or more of the devices to the control unit. Moreover, the designation can be repeatedly performed during the conference.

In general, at least two of the designated devices are designated as audience devices for the audience participants of the presentation. If the presenting participant is to have access to the assessment of the presentation in real-time, then a presenter device for the presenting participant may also be designated. Otherwise, the presenting participant can access stored information about the audience participant's assessment of the presentation at a later point in time.

During the presentation, the control unit receives inputs from the audience devices. Each of the inputs is indicative of an assessment of the presentation at a point in time by the audience participant at the audience device. For example, an audience participant at an audience device can provide a vote, judgment, or other input that the presenting participant is or is not off-topic, that the audience participant is or is not interested in the presentation, or that the audience participant does or does not understand the presenting participant. These and other appropriate inputs can be made by the audience participants depending on the implementation.

After receiving the inputs, the control unit processes the received inputs and generates an indication for the presenting participant. The indication gives the assessment of the presentation by the audience participants based on the processed inputs.

In general, the presentation can be an audio conference, a video conference, a mixed audio and video conference, or a lecture. Therefore, the control unit can be a server having the designated devices communicatively coupled thereto via one or more networks. Additionally, the control unit can be a multipoint control unit, and one or more of the devices can be conferencing endpoints communicatively coupled to the multipoint control unit via one or more networks. Moreover, the devices can also include peripheral devices used by the presenting and audience participants and can be laptops, cellphones, tablet PCs, etc.

When the presenting device is configured to receive the generated indications during the presentation, the control unit can send the indication to the presenter's device. In turn, the presenter's device can notify the presenting participant of the audience participants' assessment in real-time by either displaying a graphic on the device's screen, producing an audible tone, vibrating, or the like.

In a conference especially, the participant who is presenting (or speaking) may change at any given point in the conference. Therefore, the control unit can change the designation of the presenter device during the presentation; at which point, the indication generated for the changed presenter device is based on the input received at the control unit after the change. In this way, each new presenter can receive new assessments from the audience participants.

Rather than strictly processing each received input without differentiation, the control unit can process the inputs received from the audience devices only at predetermined times, can weigh the received inputs based on one or more weightings, and/or can time-average the received inputs over time. Additionally, when processing the received inputs, the control unit can determine that a value of the received inputs exceeds a given threshold so the control unit can then generate the indication in response to the value exceeding that threshold. These forms of processing may help filter all of the audience inputs for better communication to the presenting participant.

When generating the indication for the presenting participant, the control unit can make the indication available for access at the control unit by the device designated for the presenting participant. This can be done in real-time, for example, by allowing the presenter's device to access the indication via a network connection, such as via the Internet or Wi-Fi. Alternatively, the presenting participant can access the information after the presentation. In this case, the control unit can at least store the generated indications over time so the presenting participant (or even audience participants) can access the stored information and assess different aspects of the presentation.

The techniques of the present disclosure can be implemented in a programmable storage device (e.g., computer-readable medium). As such, the programmable storage device has programmed instructions stored thereon for causing a programmable control device to perform the disclosed techniques. The techniques of the present disclosure can also be implemented in a presentation control unit having suitable hardware. For example, the control unit can have at least one network interface in communication with a plurality of devices during a presentation via at least one network. Additionally, the control unit can have a processing unit in communication with the at least one network interface. The processing unit can be configured to perform the various techniques disclosed herein.

The foregoing summary is not intended to summarize each potential embodiment or every aspect of the present disclosure.

### BRIEF DESCRIPTION OF THE DRAWINGS

FIG. 1 shows a conferencing system for receiving, aggregating, and processing off-topic voting inputs during a conference.

FIG. 2A shows an example user interface for an audience participant to input a vote on a peripheral device.

FIG. 2B shows an example of how an off-topic notification can be displayed to a presenter.

FIG. 3 shows a flow chart demonstrating operation of the off-topic notification system.

FIG. 4 shows another system for receiving, aggregating, and processing off-topic notifications during a presentation, such as a meeting or lecture.

### DETAILED DESCRIPTION

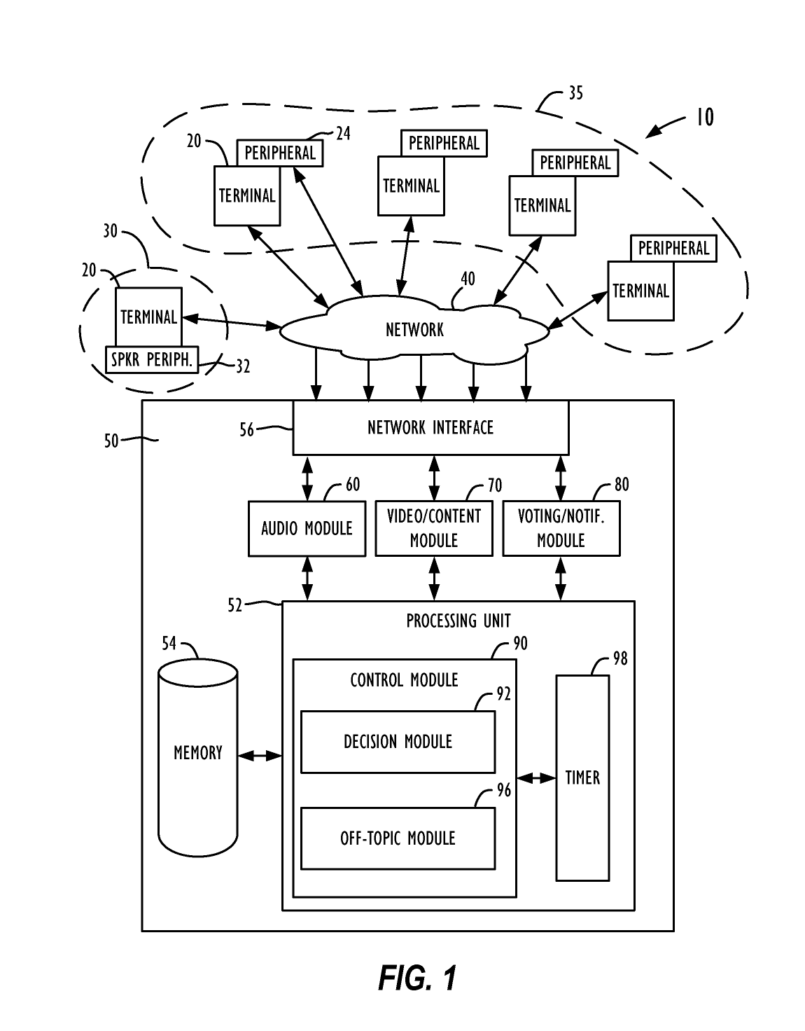

FIG. 1 shows an exemplary conferencing system 10 for receiving, aggregating, and processing off-topic voting inputs during a conference. The conferencing system 10 has endpoints 20 connected over communication networks 40 to a multipoint control unit (MCU) 50. Although described herein for videoconferencing between endpoints 20 capable of transmitting both audio and video, the system 10 can be an audio conferencing system in which only audio is transmitted between endpoints 20. Additionally, the system 10 can be a mixed audio and video conferencing system in which some endpoints 20 participate as videoconferencing endpoints and others participate as only audio conferencing endpoints.

During a conference, the endpoints 20 provide audio and/or video signals for the conference. Thus, each endpoint 20 can have a loudspeaker, a display, a camera, a microphone, a user control device, or any combination thereof, and the endpoints 20 can be speaker phones, videoconferencing units, computers, or any other typical conferencing device.

The endpoints 20 may also be accompanied by peripheral devices 24 to receive user input. As discussed in more detail later, a participant of the conference uses the peripheral device 24 or the endpoint 20 to provide an input, a vote, or a judgment assessing the conference being conducted. In general, the input proved by the participant can be directed to how the conference is currently proceeding, such as whether the conference is off-topic, whether the participant has lost interest in the current topic or the presenter, whether the conference needs to move on to another topic, whether the participant needs more information about the current topic, etc.

Participants at the endpoints 20 can use a variety of peripheral devices 24, including: computers, mobile phones, tablet computers, instant messaging (IM) clients, and video systems, among others to input their votes. In fact, a given endpoint 20 and peripheral device 24 may be separate devices functionally connected, or they may be the same device or module.

For example, those peripheral devices 24 that are separate from the local videoconferencing endpoint 20 can communicate with the local endpoint 20 using an appropriate interface, such as Wi-Fi, Bluetooth, IR signal, mobile wireless network 4G/3G interface, NFC, etc. Peripheral devices 24 can also communicate with the MCU 50 over a network connection 40 using IM, e-mail, text message, a standardized or proprietary protocol, etc. For an audio conference, an endpoint 20 having an audio conferencing phone may accept touch tones from the participants as the vote or inputs. Advantageously, the MCU 50 handling the conference may already be able to remove the touch tones from the conference audio so that the tones are not relayed to other endpoints 20. At the same time, the MCU 50 can detect the touch tones using techniques known in the art to assess the input according to the purposes disclosed herein.

During the conference, the MCU 50 receives the audio/video signals from the endpoints 20, processes them for output, and then distributes the processed signals to the endpoints 20 according to the criteria of the conference. The particular details and functionality of various components of the MCU 50 are known in the art and are not described in exhaustive detail herein. (See e.g., U.S. Pat. No. 6,496,216 and U.S. Patent Pub No. 2002/0188731, which are incorporated herein by reference in their entireties.) Additionally, the MCU 50 receives the participants' votes from the peripheral devices 24, processes them for output, and then distributes signals or messages to the appropriate endpoints 20 or peripherals 24 according to the purposes disclosed herein.

Typically, the MCU 50 can be an independent node in the system 10 or can be located within an endpoint 20 in the conference. It may also be on a web server such that it may handle multiple separate conferences at any given time. The endpoints 20 can be video communication endpoints, and the communication networks 40 can be packet-based networks, circuit switched networks, and/or other networks or communication protocols, such as ISDN, ATM, PSTN, cellular and/or IP. Information communicated between the endpoints 20 and the MCU 50 includes control signals, audio information, video information, and data. Information communicated between the peripheral devices 24 and the MCU 50 includes control signals and data. Yet, the disclosed system 10 and methods are not limited to a particular type of communication protocol or network.

As shown, the MCU 50 includes a processing unit 52, memory 54, and other necessary components. A network interface 56 connects the MCU 50 to the communication networks 40. Coupled to the network interface 56, an audio interface or module 60 allocates audio resources such as audio ports and the like for the conference, a video interface or module 70 allocates video resources such as video ports and the like, and a voting/notification interface or module 80 allocates data resources for data. A control module 90 controls operation of the MCU 50 and includes logic elements that process instructions and that control the audio module 60, video module 70, and voting/notification module 80. Each of these various modules 60/70/80/90 can be implemented through hardware, software, or a combination thereof in the MCU 50.

The control module 90 can be a host computer or an internal module of the MCU 50. As schematically shown, the control module 90 has a decision module 92 and an off-topic module 94. The control module 90 may also be connected to a timer 98, which will be discussed in more detail below.

At times during a conference, a speaker at one particular endpoint 20 may be presenting (i.e., speaking, displaying content, etc.) for distribution to the other endpoints 20. The MCU 50 designates at least one endpoint 20 as the speaker endpoint 30 and designates the remaining endpoints 20 as non-speaker or audience endpoints 35. The speaker endpoint 30 may have a speaker peripheral device 32 that can provide off-topic notifications to the current speaker or presenter. (As before, the speaker peripheral device 32 and speaker endpoint 30 may be functionally connected or the same device or module.)

Determining which endpoint 20 to designate as the speaker endpoint 30 can be done in various forms. In general, the designation can be initially performed when reserving the conference, starting the conference, or connecting the endpoints 20 to the MCU 50. Additionally, the designation of speaker and audience endpoints 30 and 35 can be made repeatedly at subsequent intervals during the conference to handle the dynamic nature of the conference. In one technique for designating a speaker endpoint 30, a manual request may be sent from the endpoint 20 to the MCU 50 to change from being an audience designation to a speaker designation.

After at least one endpoint 20 has been designated as the speaker endpoint 30 by the MCU 50, the MCU 50 can begin handling or processing off-topic votes or related types of input from the audience endpoints 35. During the conference, participants at the audience endpoints 35 may signal that a discussion is off-topic by voting from their peripheral devices 24. Voting may take the form of pushing a button, clicking an icon, sending a text or instant message, or various other forms. Voting input from an audience endpoint 35 may be limited to a certain number of votes over a time duration (for example, one time every minute or every 90 seconds). This will reduce the potential for excessive voting from a small number of audience endpoints 35.

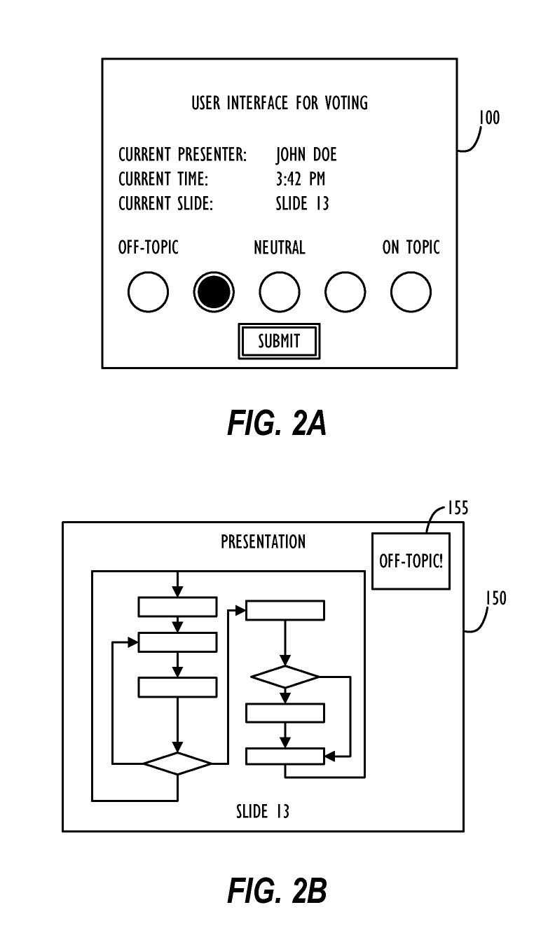

Looking briefly at FIG. 2A, an example of a user interface 100 is shown for an audience participant to input a vote on a peripheral device 24. As will be appreciated, the interface 100 can take any number of forms to allow the audience participant to input a vote, and the interface 100 can display various types of useful information. Therefore, the interface 100 in FIG. 2A is meant to be illustrative.

In general, the audience participant interface 100 can display presentation information, such as the presenter's name, the current time, and presentation information (such as current slide or current topic). The interface 100 may also indicate the time (not shown) before the audience participant can input his/her next vote. In the audience participant interface 100 are voting buttons to input a vote. Available input can include simple indications of whether the audience participant is interested in the current topic or not, or the indications may have a gradation, as is shown. These and other forms of input can be provided.

Returning to FIG. 1, the MCU 50 receives the off-topic votes from the audience endpoints 35 and determines whether to display an off-topic notification on the speaker's peripheral device 32 at the speaker endpoint 30. In one way to do this the MCU 50 averages the audience voting over a period of time. If the MCU 50 determines that a threshold has been met, the MCU 50 sends an off-topic notification or indication to the speaker endpoint 30.

Once a notification is sent, the speaker's peripheral device 32 can display an off-topic notification from the MCU 50 to the speaker. In general, the off-topic notification may be shown in a singular display that shows “Off-Topic” (or a similar message indicating audience sentiment) after the minimum threshold is met. An off-topic notification does not have to be visual; the speaker peripheral device 32 may vibrate or issue an audible notification when the threshold has been met. The threshold helps to avoid initiating the off-topic notification when only a small percentage of the audience thinks that the conference is straying from the main topic. However, the off-topic notification may also operate without a threshold; for example, a measure may be calculated and displayed in a meter format where the presenter can see what percentage of the audience is currently dissatisfied with the conference.

FIG. 2B shows an example of a display 150 for a presenter. Preferably, this display 150 is only viewable by the presenter so that audience participants are not aware of what information is ultimately displayed to the presenter, although other systems may instead allow for such a situation. In any event, the display 150 shows an off-topic notification 155 to the presenter, presumably after the threshold of off-topic votes has been met. In other scenarios, the off-topic notification 155 may be in the form of a metered or a gradient scale on the display 150. In still other scenarios, the off-topic notification 155 may not be visual. For example, the presenter may be notified from the presenter's peripheral device 32 by an action such as a vibration or by an audible tone when the threshold of votes has been met.

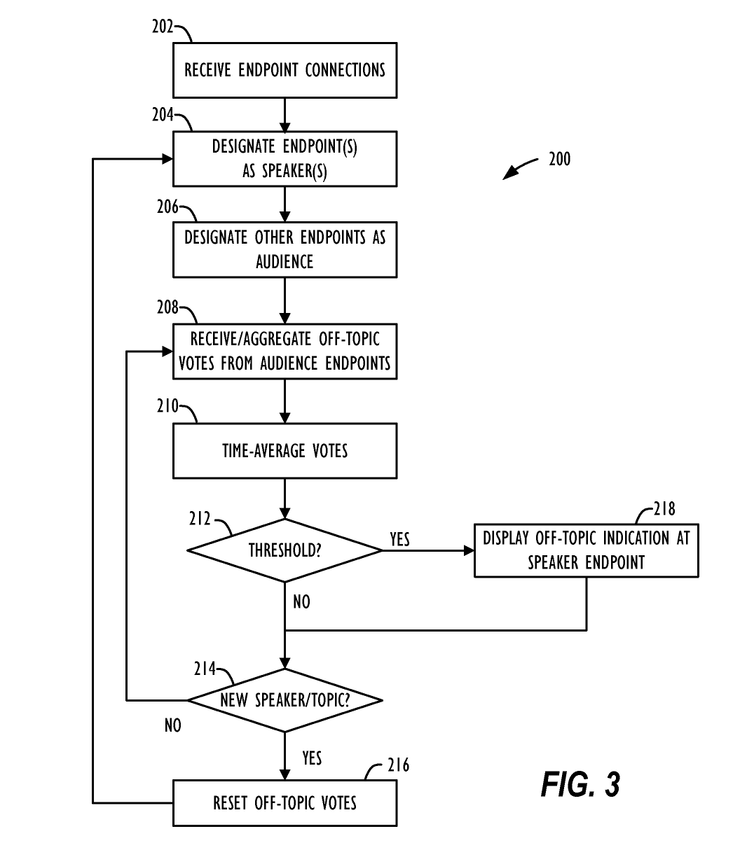

Having an understanding of the system 10 for aggregating audience input and providing off-topic notifications, discussion now turns to an example method 200 for determining whether to display an off-topic notification, as shown in FIG. 3. Initially, the network interface 56 of the MCU 50 receives multimedia communications from the endpoints 20 via the network connections 40 and processes the multimedia communications according to an appropriate communication standard (Block 202).

The speaker(s) and the audience participants all register to a specific meeting on the MCU 50. The MCU 50 then designates one or more endpoints 20 as speaker endpoints 30 (Block 204). These speaker endpoints 30 should have speaker peripheral devices 32 that can present an off-topic notification sent by the MCU 50. The MCU 50 then designates the remaining endpoints 20 as audience endpoints 35 (Block 206). If there are multiple speaker endpoints 30, the MCU 50 may be configured to designate these endpoints as both speaker and audience endpoints 30 and 35. This would allow one speaker to vote as an audience participant from their endpoint during another speaker's discussion. The audience endpoints 35 also have peripheral devices 24 that allow the audience participants to indicate, or vote, that a discussion is becoming off-topic.

The MCU 50 then handles and processes audience votes as the conference progresses, and the MCU 50 aggregates the audience's input from the various peripheral devices 24 (Block 208). Audience voting is continually or frequently aggregated by the MCU 50 as votes may be received from the audience endpoints 35 at any time.

Once a vote is registered by the MCU 50 from an audience endpoint 35, the MCU 50 preferably assigns the vote a lifespan over which it is valid. In this manner, a vote from an audience endpoint 35 at the start of a conference is not factored in after the vote's lifespan. This may be done because the direction of a discussion or presentation can change relatively quickly, and a discussion which had been off-topic to one audience participant at one moment may not be later. Each vote from an audience endpoint 35, thus, has a time frame in which it is valid. This time frame may be set by default, for example, at one minute. It may also be variable so it can be adjusted by a system administrator or the conference host or so it can be automatically adjusted by the MCU 50.

Because an off-topic vote has a time frame for which it is valid, the MCU 50 time averages the votes (Block 210). As noted above each off-topic vote is valid from the time at which it is received until the time at which the valid lifetime is exceeded. Within the MCU 50, the off-topic module 96 in the control module 90 therefore receives, aggregates, and tracks the votes, and the off-topic module 96 also tracks the votes' lifespans by using time data from a timer 98. In this manner, the MCU 50 discards votes which have exceeded their lifespan, maintains valid votes, and incorporates new votes received during Block 208 to produce a time-averaged result.

The MCU 50 then compares the time-averaged result with an off-topic threshold (Decision 212). The off-topic threshold may be set as a percentage or an absolute value, although any other fixed or variable threshold could be used. As a percentage, for example, the threshold might be set to a value of 40% of all audience participants having voted within the time period that the conference is off-topic. If, for any given time, the time-averaged value of off-topic votes exceeds the set threshold, then Block 218 is triggered, and the MCU 50 sends an off-topic notification for display at the speaker's endpoint 30.

As noted, the system 10 preferably is configured such that the presenter does not receive feedback until the average off-topic votes from the audience reaches a certain threshold. Alternatively, as mentioned above, the system 10 may be configured such that the off-topic notification is displayed on a metered or a gradient scale display. In any event, this off-topic notification is preferably fed back in a subtle way to the current speaker via the speaker's peripheral device 32.

Whether or not the off-topic notification is triggered and displayed, the MCU 50 also preferably checks whether a new speaker or new topic has begun (Decision 214). If so, then the off-topic voting is reset (Block 216), as existing off-topic votes would no longer be applicable. The determination of when a new speaker has begun or a new topic is being discussed could be input into the MCU 50 by a conference host, or it may be determined automatically by the MCU 50 based on a predetermined schedule. In some situations, the MCU 50 could also determine that a new topic had begun based on reaching a trigger point in a video or content feed.

The process 200 may also incorporate the concept of adjusting for a weighted average. In a conference setting, for example, there may be many different groups of people who are audience participants for a presentation. If a presenter is making a presentation that is directed at a specific subset of people, then it might be preferable that the audience participants who are within the targeted groups have a higher weighted vote than those who are not. The weighting could be accomplished in multiple ways. Votes received from the audience endpoints 35 of non-targeted audience participants could be configured such that the time between voting inputs is increased (i.e., reducing the number of votes through a non-targeted audience endpoint 35 over a given period of time). The weighting could also be performed by assigning a higher value or weight to a targeted participant's vote relative to a non-targeted participant's vote.

In some scenarios, multiple audience participants might share one endpoint 20. This might occur when people gather in a conference room to view a presentation or listen to a conference call, for example. In this scenario, an individual audience participant could vote through their individual peripheral device 24. As an alternative, audience participants can each have a specific ID that could be input into an audio conference keypad to register an individual vote at the shared endpoint 20.

Some videoconferences are conducted with telepresence systems in which each participant has his or her own dedicated camera for sending video to other endpoints 20. As will be appreciated, the overall intent of the telepresence conference is to make all of the participants feel that they are gathered together in the same room. In a telepresence conference, the MCU 50 has an indication of which participant is currently speaking based on the audio inputs. Therefore, notifications of audience participant's voting input can be sent discretely and anonymously only to the current participant speaking. In this way, none of the other participants may be able to see any of the notifications being sent to the current speaker, and the notifications to the current speaker preferably do not indicate which of the other participants have provided input. Once a new speaker is detected in the telepresence conference, past voting input can be discarded because it may apply to the previous speaker.

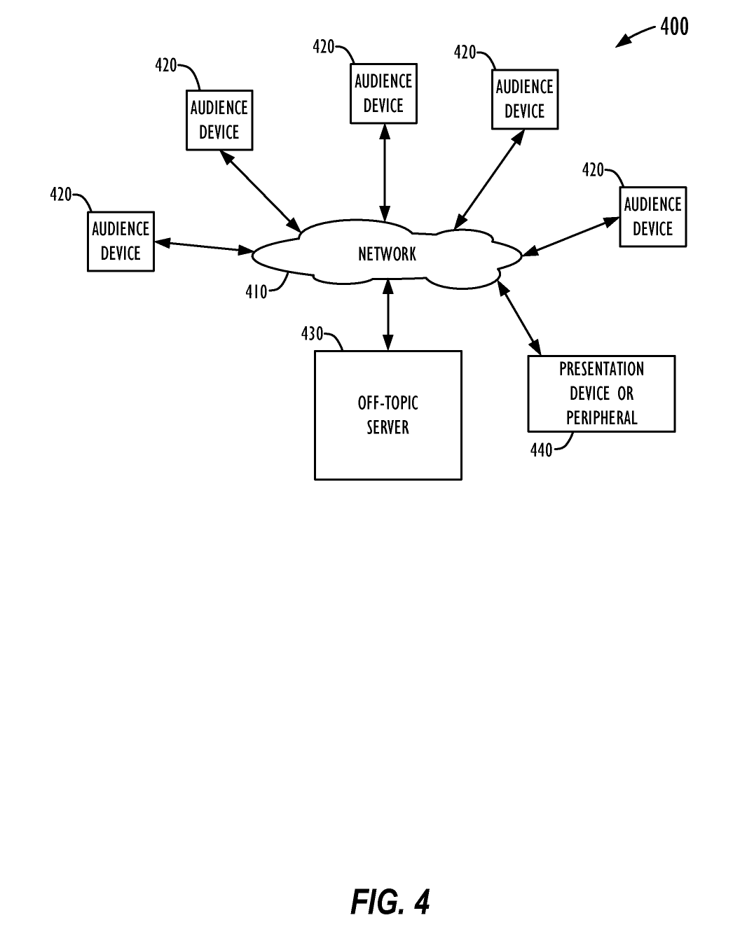

The previous discussion focused on a conference that uses an MCU 50 as a control unit for handling audience inputs and presenter notifications. However, the system according to the present disclosure may be adapted to work purely through software on non-specialized hardware as well. Referring to FIG. 4, a system 400 according to the present disclosure includes an off-topic server 430, which can be a publicly or privately available server and can host a website. Participants are able to register a meeting, conference, lecture, class, etc. on the server 430. The meeting, conference, lecture, class, etc. (simply referred to herein as “presentation”) can be attended in person, attended over the Internet, attended remotely or from a prerecorded session. The participants can view and enter input (e.g., feedback) about the meeting so that others (i.e., the presenter) are aware of the general sense of the meeting and whether it is on or off topic.

As shown in FIG. 4, for example, a presentation device 440 and multiple audience devices 420 (i.e., laptops, cellphones, tablet PCs, etc.) log into a presentation at the server 430. In general, the server 430, audience devices 420, and presentation device 440 can be similar to the respective devices described previously so that details are not repeated here. Accordingly, the audience devices 420 may be portable if the audience participants are attending a live meeting or lecture. The presentation device 430 can include the off-topic server 430, can directly connect to the off-topic server 430, or can connect with the server 430 via a network connection 410 (e.g., Wi-Fi, LAN, WAN, etc.). The audience devices 420 can connect with the server 430 in the same way.

In addition to managing standard functions such as login and registration of the audience devices 420, the server 430 manages the votes from the audience devices 420 through various communication means, such as IM client, text message, a standardized or proprietary protocol, etc. over the network 410 (e.g., Wi-Fi, LAN, WAN, etc.). Receiving input from the audience devices 420, the server 430 subsequently sends an off-topic notification to the presentation device 440 according to the procedures disclosed herein, and the presentation device 440 or another device that has been registered to the presenter could display the off-topic notification.

Therefore, similar to the previously described system, the presenter in the system 400 of FIG. 4 registers a presentation (e.g., conference, meeting, lecture, or the like) on the server 430, which provides a conference ID. Audience participants then log in to the server 430 for the scheduled presentation by using the appropriate conference ID. In turn, the server 430 can assign each audience participant a unique user ID. As the presentation then progresses, audience participants use their peripheral devices 420 to enter input via a user interface (as in FIG. 2A), and the presenter receives notifications of the polled input in real-time to assess his/her presentation via a user interface (as in FIG. 2B).

While audience input may be received in real-time by the presenter, the input can also be accessible to the presenter from the server 430 at a later time. For example, polling of input from audience participants can be recorded at the server 430 with the input having timestamps associated with specific times in the presentation and associated with specific slides, video, audio, or other detail of the presentation. Later, after the presentation, the presenter can review the polled input stored on the server 430 and can compare it to a recording (video or audio) of his meeting to assess his/her performance, determine what parts of the meeting are less informative or confusing, etc. Similarly, an audience participant who is watching a prerecorded session could view and access the data stored on the server 430. The audience participant would have the ability to know in advance which parts of the lecture are on-topic or off-topic and can make viewing or listening decisions accordingly. Additionally, the audience participant could input his/her voting preferences into the prerecorded session. The server 430 could then incorporate the new polled input into the existing polled input data for future reviews.

The audience participants registered with the server 430 can be the general, targeted audience of the presentation, or only a select number of audience participants may be registered to give audience input. For example, moderators or co-workers of the presenter may be the only audience participants allowed to register to give feedback to the presenter during the presentation. These specific participants may be able to judge the audience's interest better than the presenter or may be able to better direct the presentation's progress since they are situated as third-party observers, for example.

The techniques of the present disclosure can be implemented in digital electronic circuitry, or in computer hardware, firmware, software, or in combinations of these. Apparatus for practicing the disclosed techniques can be implemented in a computer program product tangibly embodied in a machine-readable storage device for execution by a programmable processor; and method steps of the disclosed techniques can be performed by a programmable processor executing a program of instructions to perform functions of the disclosed techniques by operating on input data and generating output. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

The foregoing description of preferred and other embodiments is not intended to limit or restrict the scope or applicability of the inventive concepts conceived of by the Applicants. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A method of indicating audience assessment of a presentation conducted by a presenting participant to audience participants of the presentation, the method comprising:
designating devices in the presentation at a control unit, at least two of the designated devices being designated as audience devices for the audience participants of the presentation;
receiving inputs from the audience devices at the control unit during the presentation, each of the inputs indicative of an assessment of the presentation at a point in time by the audience participant at the audience device;
processing the received input at the control unit; and
generating an indication at the control unit for the presenting participant, the indication giving the assessment of the presentation based on the processed inputs.

2. The method of claim 1, wherein the presentation is an audio conference, a video conference, a mixed audio and video conference, a meeting or a lecture.

3. The method of claim 1, wherein the control unit is a server having the designated devices communicatively coupled thereto via one or more networks.

4. The method of claim 1, wherein the control unit is a multipoint control unit, and wherein one or more of the devices comprise conferencing endpoints communicatively coupled to the multipoint control unit via one or more networks.

5. The method of claim 4, wherein designating the devices comprises initially performing the designations when reserving a conference for the presentation, performing the designations when starting the conference, performing the designations when communicatively connecting one or more of the devices to the control unit, or repeatedly performing the designations during the conference.

6. The method of claim 1, wherein designating the devices in the presentation at the control unit further comprises designating at least one of the devices in the presentation as a presenter device for the presenting participant.

7. The method of claim 6, wherein generating the indication at the control unit for the presenting participant comprises sending the indication from the control unit to the presenter device.

8. The method of claim 6, wherein designating the devices in the presentation at the control unit further comprises changing the designation of the presenter device during the presentation, whereby the indication generated for the changed presenter device is based on the input received at the control unit after the change.

9. The method of claim 1, wherein processing the received inputs at the control unit comprises processing the inputs received from a given one of the audience devices only at predetermined times.

10. The method of claim 1, wherein processing the received inputs at the control unit comprises determining at the control unit that a value of the received inputs exceeds a threshold.

11. The method of claim 10, wherein generating the indication comprises generating the indication in response to the value of the received inputs exceeding the threshold.

12. The method of claim 1, wherein processing the received inputs at the control unit comprises weighting the received inputs based on one or more weightings.

13. The method of claim 1, wherein generating the indication at the control unit for the presenting participant comprises making the indication available for access at the control unit by the device designated for the presenting participant.

14. The method of claim 1, wherein the indication comprises a graphic display, an audible tone, or an action on the device designated for the presenting participant.

15. The method of claim 1, wherein a given one of the inputs indicative of the assessment of the presentation by the audience participant at the audience device comprises a judgment that the presenting participant is or is not off-topic, that the audience participant is or is not interested in the presentation, or that the audience participant does or does not understand the presenting participant.

16. The method of claim 1, wherein processing the received inputs comprises time-averaging the received inputs over time.

17. The method of claim 1, wherein the acts of processing the received inputs and generating the indication occur during the presentation.

18. The method of claim 1, further comprising:
storing at least the generated indications; and
providing access to the stored indications by the audience participants or the presenting participant.

19. A programmable storage device having programmed instructions stored thereon for causing a programmable control device to perform a method according to claim 1.

20. A presentation control unit, comprising:
at least one network interface in communication with a plurality of devices during a presentation via at least one network; and
a processing unit in communication with the at least one network interface, the processing unit configured to:
designate the devices in the presentation, at least two or more of the devices being designated as audience devices for audience participants of the presentation,
receive inputs from the audience devices, each of the inputs indicative of an assessment of the presentation by the audience participant at the audience device,
process the received inputs, and
generate an indication for a presenting participant of the presentation, the indication giving the assessment of the presentation based on the processed inputs.

21. The control unit of claim 20, wherein the presentation is an audio conference, a video conference, or a mixed audio and video conference.

22. The unit of claim 21, further comprising an audio interface in communication with the at least one network interface and handling input and output audio for the conference.

23. The control unit of claim 20, wherein the control unit comprises a web server or a multipoint control unit.
